(19) United States
(12) Patent Application Publication
(10) Pub. No.: US 2016/0234267 A1
(43) Pub. Date: Aug. 11, 2016

(54) SHARING DIGITAL CONTENT USING AN INTERACTIVE SEND SERVICE SYSTEM

(71) Applicant: Adobe Systems Incorporated, San Jose, CA (US)

(72) Inventor: Vivek Hebbar, Cupertino, CA (US)

(21) Appl. No.: 14/616,417

(22) Filed: Feb. 6, 2015

(51) Int. Cl. H04L 29/06; G06F 3/0484; G06F 3/0482

(52) U.S. Cl. CPC H04L 65/403; G06F 3/0482; G06F 3/04842

(57) ABSTRACT

The present disclosure is directed toward a send service system that enables a user to customize and control the sending of multiple files to one or more recipients. In addition, the send service system may use templates to allow a user to combine multiple files, stored by different third-party content providers, into a presentation, and to share the presentation with one or more recipients. By creating a content presentation, the send service system enables the user to share content from multiple files in an organized and controlled manner.

### BACKGROUND

1. Technical Field

One or more embodiments generally relate to sending content items across a network. More specifically, one or more embodiments relate to an interactive send service system that enables a user to organize content items and provide to one or more recipients access to the organized content items over a network.

2. Background and Relevant Art

As the quality of digital content and media improves, the size of digital content and media files also increases. To illustrate, when a video is stored as a high-definition video, as opposed to a standard definition video, the file size of the high-definition video can be three to six times larger, depending on the quality of the high-definition video (e.g., 720P and 1080P video). Furthermore, recent video standards are introducing formats, such as ultra high-definition video (e.g., 4K HD), which requires a file size that is over twenty times larger than the same video stored in standard definition. Likewise, the size of digital image files is increasing as modern digital cameras are increasingly capturing higher resolution images.

As the size of digital content and media files increases, the ability to send large files via the Internet becomes more difficult. Conventionally, one solution to sending large files is to employ a file sending service that allows a user to upload a file to the file sending service. The user can then share a link with a co-user that allows the co-user to access and download the file from the file sending service. In this manner, conventional file sending services allow users to share files with co-users across a network that are otherwise difficult or impossible to share using traditional communication methods, such as email or instant message.

Conventional file sending services, in many cases, send a static link that points to a storage location on a server from where a specific file may be downloaded. In the event that a user wishes to provide access to multiple files, many conventional file sending services send a separate static link for each of the multiple files. For example, a conventional file sending service may send a message to a co-user that includes individual links to each of the multiple files. The sending of multiple individual links that point to multiple files, however, can result in a number of disadvantages, as discussed below.

One disadvantage of sending multiple individual links that correspond to multiple individual files is that the user providing access to the multiple files is unable to control the order in which the co-users view the shared files. For example, a user may wish to provide access to a series of documents in a particular order. Conventional file sending services, however, allow co-users the ability to access the multiple files independently, regardless of any particular order (e.g., a co-user can select any one of the multiple individual links in any order).

Along similar lines, conventional file sending services do not allow a user to organize multiple shared files into a single customized layout or arrangement. For instance, the user may want to combine multiple digital photos into a collage, or the user may desire to combine multiple documents in a particular layout, such as for a marketing/sales brochure. In contrast to a user's desire to customize the presentation of multiple files, conventional file sending services are limited to only providing access to individual files. Thus, a user's desired presentation of the files is difficult to achieve using a conventional file sending service.

An additional disadvantage of conventional file sending services is that many conventional file sending services do not allow a user to ensure that co-users download each of the multiple files. Rather, because conventional file sending services provide multiple individual links that correspond with multiple individual files, a co-user may choose not to select every individual link, an in turn, not download every file. Therefore, many conventional file sending services do not provide a user the ability to ensure that a co-user downloads the content that the user wants to provide to the co-user.

In addition presentation disadvantages, conventional file sending systems also have several disadvantages that relate to a user accessing and uploading multiple files to a file sending system. For example, in order to upload a file to a conventional file sending systems, often the user must store the file on a local storage of the user's computer (e.g., the hard drive). Although traditionally a user would typically maintain the majority of files on a local storage of a computer. With recent advances in remote storage technology (e.g., cloud storage), however, a user now often stores the majority of the user's files using a remote storage service. In addition, it is common for users to store files using multiple remote storage services.

Unfortunately, conventional file sending services do not interface with remote storage services, thus increasing the steps and amount of time needed for a user to upload files to a conventional file sending service. For example, in the case where a user maintains the user's files on remote storage, the user has to access and download the files from the remote storage to a local storage. Next, the user must gain access to the conventional file sending service. Then, the user can locate the files on the local storage for uploading to the conventional file sending service. In the case where the user has files stored using several remote storage services, the above process has to be repeated several times, thus further increasing the amount of time needed for a user to share files using conventional file sending services.

Thus, there are several disadvantages to current methods for sending multiple files using conventional file sending services.

### SUMMARY

One or more embodiments described herein provide benefits and/or solve one or more of the foregoing or other problems in the art through systems and methods that allow a user to use a send service system to easily and efficiently obtain content from various sources, organize the content, and share the organized content with co-users. In particular, example systems and methods provide a send service system that allows a user to interactively customize a content presentation using multiple content items from various sources. In addition, example systems and methods described herein allow a user to use a send service system to access content from third-party content providers to include in the customized content presentation. Furthermore, the systems and methods described herein allow a user to provide one or more co-users with access to the customized content presentation.

In particular, in one or more embodiments, the systems and methods include providing a user, via a send service system, a plurality of templates that can be used to create a content presentation. Each of the plurality of templates can include a workflow that corresponds to various content presentation characteristics (e.g., presentation type, style, format) associated with presenting various types of content (e.g., digital photos, digital video, text). Therefore, via one or more embodiments of a send service system, a user can select a template from the plurality of templates for the purpose of creating a content presentation to share with co-users.

In addition to selecting a template, the systems and methods described herein allow a user to access, via the send service system, content used to populate the template. In one or more embodiments, the send service system can directly interface with one or more third-party content providers (e.g., third-party cloud storage providers) to access content the user wishes to include in a content presentation. In addition, the systems and methods described herein include an interactive interface, provided as part of the send service system, that allows a user to customize a content presentation, for example, by allowing the user to modify the selected template and/or selectively arrange content within the selected template.

Upon a user creating a content presentation, the systems and methods allow the user to send, by way of the send service system, an electronic communication (e.g., a message, a notification) to one or more co-users with whom the user wants to share the content presentation. Specifically, the electronic communication can enable a co-user to access to the content presentation via the send service system. For example, a co-user can interact with an access element within the electronic communication (e.g., a link, a button) to gain access to the content presentation hosted by the send service system.

As will become more apparent with the additional description below, the systems and methods described herein allow a user to easily and efficiently access content, organize content, and create a content presentation to share with co-users, all from within a send service system. Due to the user's ability to customize the content presentation, the user can share content in a layout and/or arrangement preferred by the user. In addition, due to the send service system interfacing with third-party content providers, a user can efficiently access remote content located at third-party content providers from within the send service system. Thus, the systems and methods described herein provide an interactive send service system that allows a user to share content with co-users in an efficient, easy, and customizable way compared with conventional file sending systems.

Additional features and advantages will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore considered to be limiting of its scope, the invention will be described and explained with additional specificity and detail through the use of the accompanying drawings in which:

FIG. 1 illustrates a block diagram of an exemplary environment in which a send service system interfaces with users and third-party content provider in accordance with one or more embodiments;

FIG. 2 illustrates a schematic diagram of a send service system in accordance with one or more embodiments;

FIGS. 3A-3B illustrates an example process flow diagram that shows interactions between a user client device, a send service system, third-party content provider, and a recipient client device in accordance with one or more embodiments;

FIG. 4 illustrates another example process flow diagram that shows interactions between a user client device, a send service system, third-party content provider, and a recipient client device in accordance with one or more embodiments;

FIG. 5 illustrates a flowchart of a series of acts in a method for sending multiple content items using a send service system in accordance with one or more embodiments;

FIG. 6 illustrates a flowchart of a series of acts in a method for sending multiple files to one or more recipients using a send service system in accordance with one or more embodiments; and

FIG. 7 illustrates a block diagram of an exemplary computing device in accordance with one or more embodiments.

### DETAILED DESCRIPTION

One or more embodiments described herein include an interactive send service system that allows a user to efficiently obtain content items, customize the presentation of content items, and provide access to the customized presentation to one or more recipients across a network. Generally, one or more embodiments of the send service system allows a user to select a template within which the send service system incorporates user specified content items to create a content presentation. Upon creating a content presentation, the send service system can send an electronic communication to user specified recipients, the electronic communication including an access element that enables the recipients to access the content presentation via the send service system.

As briefly mentioned above, one or more embodiments of a send service system may maintain a plurality of templates for organizing various types of content items, or combinations of content items. For example, a send service system may provide one or more template options to a user and prompt the user to select a template. Additionally or alternatively, the send service system may apply a template filter or otherwise restrict which templates are presented to a user based on the type of content items the user has specified. For example, the send service system may offer only templates corresponding to a workflow category (e.g., image viewing workflows, legal workflows, web learning workflows, marketing presentation workflows) based on, for example, a content item type(s), a number of content items, an user-indicated presentation type, and/or a history of a user's past actions on the send service system.

In one or more embodiments, the send service system can provide a user an interactive platform for authoring and/or customizing templates. As such, the send service system may enable a user to modify existing templates, author new templates, or combine one or more existing templates. In one or more embodiments, the send service system may provide a web application that allows the user to author and customize templates to suite a particular workflow.

As described briefly above, one or more embodiments of the send service system can allow a user to access content items from various content sources with which to populate a template. For example, the send service system can allow the user to access content items maintained by the send service system and/or content items maintained by a client devices associated with the user (e.g., personal computer, mobile device, tablet). Additionally, example embodiments of the send service system can provide the user the ability to easily access content items maintained by one or more third-party content providers (e.g., cloud storage providers) from directly within the user service system.

In particular, in one or more embodiments, the send service system can interface with one or more third-party content providers (e.g., cloud storage provider, online file storage provider, hosting service, remote back service, virtual storage service). For example, the send service system may include an interface component that allows a user easily cause the send service system to identify, access, and use content items maintained by a third-party content provider. To illustrate, the send service system can provide an interface component that allows a user to identify a particular third-party content provider, as well as provide any user information (e.g., username and/or password) needed to access content items maintained by the third-party content provider. In addition, the interface component of the send service system can allow a user to identify and select specific content items stored by a third-party content provider. For example, the send service system can interface with a third-party content provider to access, search, identify, and obtain content items stored by the third-party content provider.

Upon the user selecting a template and identifying one or more content items, the send service system can populate the selected template using the identified content items to create a content presentation. In one or more embodiments, the send service system can provide an interactive interface that allows a user to customize the content presentation by selectively arranging each of the content items within the template. For example, the interactive interface can enable a user to create a content presentation that displays multiple content items in a user-specified layout and/or arrangement. In addition, the interactive interface of the send service system can allow the user to modify the content items to be incorporated within the template (e.g., modifying the size, resolution, formatting, content, and/or other characteristics depending on a particular content item). Thus, the send service system can provide an interactive interface that provides a user the ability to personalize and customize a content presentation conveniently from within the send service system.

Upon completing a content presentation, and as generally described above, the send service system can generate an electronic communication that enables user-selected recipients to access the content presentation. For example, the send service system allows a user to select, import, or otherwise input one or more recipients to receive access to a content presentation. In one or more embodiments, the send service system can then incorporate an access element (e.g., a link, a button) in an electronic communication that is sent to the user-selected recipients. For instance, upon a recipient interacting with the access element, the send service system can provide the content presentation to the recipient. The recipient can then access, view, and otherwise experience the content presentation.

In one or more embodiments, and as part of providing access to one or more recipients, a send service system can integrate with various social media platforms. For example, the send service system may allow a user to select recipients with which to share a content presentation using the user's social media connections. Further, an example send service system can also use the user's social media account to notify the selected recipients of a content presentation. Moreover, for example, a send service system can send a social media notification to a user interested in the particular workflow category when the send service system makes a new template having the particular workflow category available.

In addition to providing access to a content presentation, in some example embodiments, the send service system can track the use of a content presentation. For example, the send service system can track which recipients have accessed or attempted to access the content presentation, or which recipients have previewed, viewed, and/or downloaded the content presentation. Further, example embodiments of a send service system can monitor how recipients progress and navigate through the content presentation. For instance, the send service system can analyze user behavior based on the tracked and monitored actions of recipients that interact with a content presentation. Based on an analysis of user behavior, the send service system can provide analytic information to a user or organization that created the content presentation, as will be described in additional detail below.

The above-described features and characteristics of the send service system disclosed herein provide a number of advantages. For example, and unlike conventional file sending services, the send service system described herein can allow a user to associate multiple content items (e.g., files, documents, images, videos, audio) together in an organized presentation rather than having each content item treated as an individual item. Accordingly, when a user shares multiple content items with one or more recipients using the send service system, the user can require that recipients access the multiple content items together, and in an order and presentation that the user specifies.

As an additional advantage, the send service system herein can provide a user with the ability to customize the presentation of multiple content items shared with recipients. For example, a user, via the send service system, can select a workflow, layout, and/or arrangement for presenting multiple content items. Additionally, by presenting multiple shared content items in a content presentation, the send service system can assist a user in presenting the multiple shared content items in a particular order directed by the user.

Moreover, unlike conventional file sending services that require a user to upload files from a user client device, one or more example embodiments of the send service system can allow a user to access and use content items stored by third-party content providers. Thus, a user can easily access and use content times that are located at a variety of storage locations while using the send service system. Thus, advantageously, a user can efficiently obtain the content items the user desires to share with one or more recipients.

Additionally, and in contrast to conventional file sending services, example embodiments of the send service system can track user behavior and provide analytic information that indicates the recipients that access, view, and/or download content that the user shares. In some example embodiments, the send service system can also track the status of each shared content item within a single content presentation with respect to each recipient. For example, one or more embodiments of the send service system can track and report whether or not a particular recipient has viewed each content item in a content presentation. Additional features and advantages will become more apparent based on the additional disclosure below.

As used herein, the term “send service system” refers to a system that operates within a digital medium environment that allows a user to selectively provide other users (e.g., recipients) with access to user-specified content over a network. In particular, a send service system can maintain content on a network accessible server (e.g., accessible over the Internet) and provide to a recipient access to the content by providing the recipient with the directory location of the content on the server.

For instance, due to the nature of a send service system, recipients cannot access content on a send service system unless the recipient is specifically provided with access to the content. For example, a send service system can maintain content using obscure filenames and/or within obscure file paths to prevent the content from unwanted access. In other cases, the send service system can use various forms of security (e.g., encryption/decryption, digital keys/certificates, passwords) to protect content from unwanted access. In some embodiments, a send service system can provide access to content for a limited period of time. The period of time can be a default period of time defined by the send service system, or alternatively, a user can specify the period of time. Although a send service system often assists users in sharing content having a large file size, a send service system can be used with content having any file size. Examples of send service systems include ADOBE SENDNOW and ABODE SEND.

As used herein the term “content” or “content item” refers generally to a compilation of digital data that can be stored on a computing device. For example, a content item can include a compilation of digital data stored in one or more file types or formats. Example file types or formats include, but are not limited to, documents, images, audio, recordings, videos, graphics, presentations, spreadsheets, or other file types or formats used to organize digital data. Additionally, content can refer to the content within a content item (e.g., text, images, headers, metadata, graphics, etc.).

As used herein, the term “template” refers to an object that provides a fillable guide for organizing one or more content items. For example, a template can comprise a pattern, stencil, design, layout, arrangement, style, and/or other configuration into which a user can incorporate content. A template can include one or more components or portions, which provide the user with different functionality. For example, a file component can store and/or display documents while an analytics component can analyze and display the results of one or more viewer's interaction with content. In one or more embodiments, templates can be categorized according to different workflows. A “workflow” as used herein, is used to describe the manner and characteristics of presenting content, for example, the order of presentation, the arrangement of content, restrictions and permissions, ability to interact with content, and any other characteristic relating to a presenting content. As described below in additional detail, a template can be populated with structured content, such as user-defined content. In some example instances, once a template is populated, a user can customize the content within the template according to user preference.

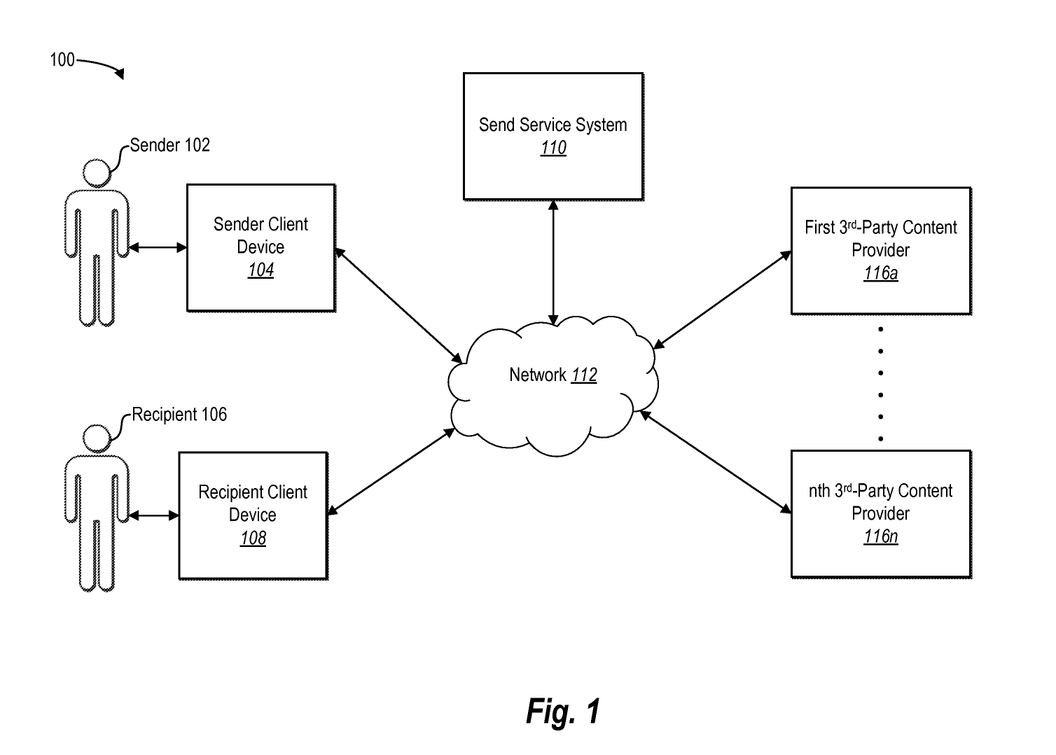

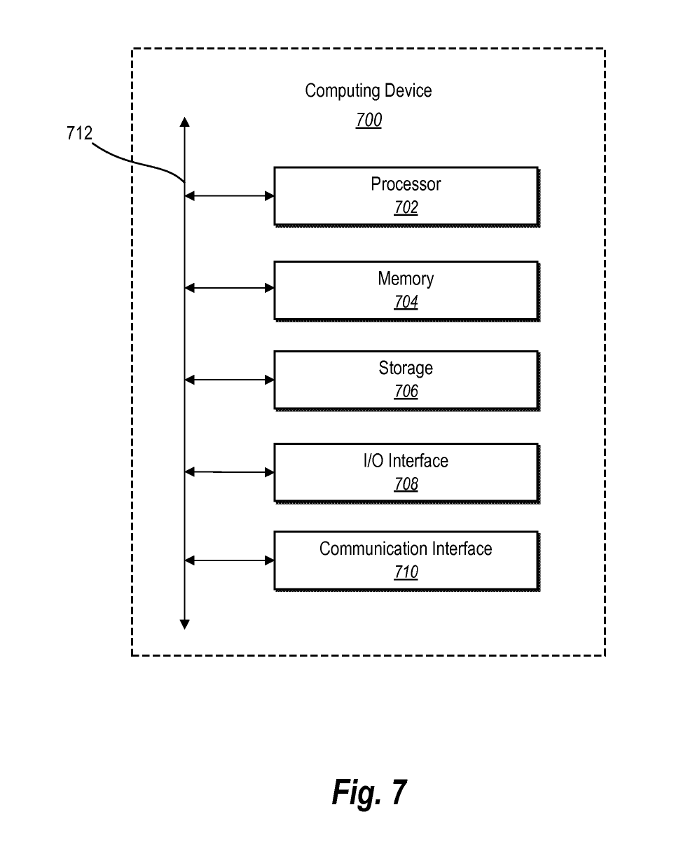

FIG. 1 is a schematic diagram illustrating a system 100 in accordance with one or more embodiments. As illustrated in FIG. 1, the system 100 can include a sender 102 and a recipient 106. In one or more embodiments, and as illustrated in FIG. 1, the sender 102 and recipient 106 can each interact with a sender client device 104 and a recipient client device 108, respectively. Examples of client devices include, but are not limited to, mobile devices (e.g., smartphones, tablets, smart watches, PDA), laptops, desktops, or any other type of computing device, such as those described in relation to FIG. 7. While FIG. 1 illustrates one sender 102 interacting with one sender client device 104 and one recipient 106 interacting with one recipient client device 108, the system 100 can include any number of senders, recipients, and/or corresponding client devices.

The system 100 can also include a send service system 110. The sender 102 can interact with the sender device 1004 to communicate with the send service system 110 via the network 112. As described in additional detail below, the send service system 110 can enable the sender 102 to share multiple content items with the recipient 106. In particular, the send service system 110 can compile multiple content items into a content presentation, maintain the content presentation at the send service system 110, provide recipients access to the content presentation, and track recipient usage of the content presentation. The send service system 110 can also provide the sender 102 additional control over how a recipient accesses, views, or interacts with the presentation of shared content, as described in greater detail below.

The system 100 can also include one or more third-party content providers. For example, FIG. 1 shows a first third-party content provider 116a and an nth third-party content provider 116n. The system 100 can include any number of third-party content providers. For convenience, the first and nth third-party content providers are collectively referred to as the third-party content provider 116. Examples of a third-party content provider can include a cloud storage service, online file storage provider, Internet hosing service, remote back service, virtual storage service, etc. The third-party content provider can store content associated with the sender 102. For instance, the sender 102 can use the first third-party content provider 116a to store the user's digital photos and videos.

As illustrated in FIG. 1, the send service system 110 can communicate with the third-party content provider 116 via the network 112. In particular, the send service system 110 can interface with one or more third-party content providers to request and receive content items maintained by the third-party content provider 116. Although FIG. 1 illustrates a particular arrangement of the sender 102, the sender computing device 104, the recipient 106, the recipient computing device 108, the send service system 110, the network 112, and the third-party content providers 116, various additional arrangements are possible. For example, the sender client device 104 may directly communicate with the send service system 110 or the third-party content providers 116.

In one or more embodiments, the network 112 may include the Internet or World Wide Web. The network 112, however, can include various other types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Example networks and network features are described below in detail with reference to FIG. 7.

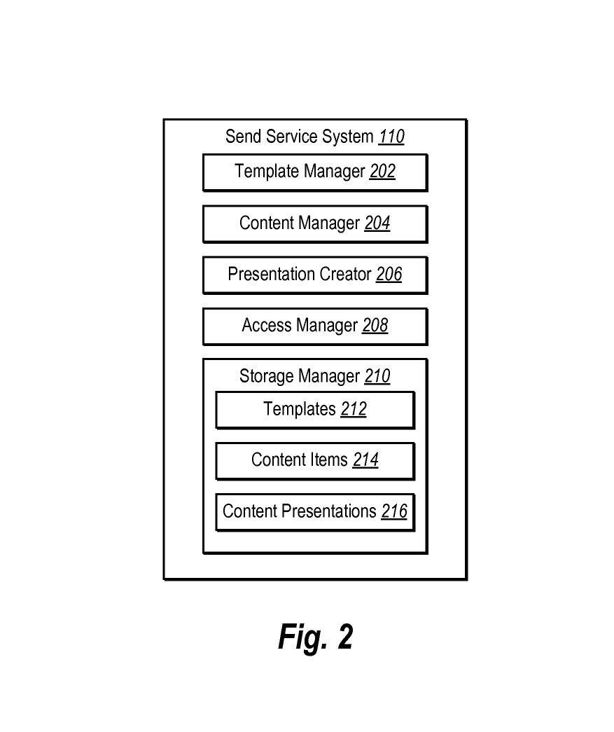

FIG. 2 illustrates a schematic diagram illustrating an embodiment of a send service system 110. The send service system 110 illustrated in FIG. 2 may be one example embodiment of the send service system 110 discussed in connection with FIG. 1. For example, the send service system 110 may communicate with one or more user client devices, one or more recipient client devices, and one or more third-party content providers, via a network, as described above in connection with FIG. 1.

As shown, the send service system 110 may include, but is not limited to, a template manager 202, a content manager 204, a presentation creator 206, an access manager 208, and a storage manager 210. Each of the components 202-210 of the send service system 110 may be in communication with one another using any suitable communication technologies. Furthermore, although the disclosure herein shows the components 202-210 to be separate in FIG. 2, any of the components 202-210 may be combined into fewer components, such as into a single facility or module, or divided into more components as may serve one or more embodiments. In addition, the components 202-210 may be located on, or implemented by, one or more computing devices, such as those described below in relation to FIG. 7.

The components 202-210 can comprise software, hardware, or both. For example, the components 202-210 can comprise one or more instructions stored on a computer readable storage medium and executable by a processor of one or more computing devices. When executed by the one or more processors, the computer-executable instructions of the send service system 110 can cause a computing device(s) to perform the methods described herein. Alternatively, the components 202-210 can comprise hardware, such as a special-purpose processing device to perform a certain function. Additionally or alternatively, the components 202-210 can comprise a combination of computer-executable instructions and hardware.

In one or more embodiments, the send service system 110 is implemented within a digital medium environment within which the send service system can provide various features and functionality to users (e.g., senders and recipients). For example, and as will be described in detail below, the digital medium environment within which the send service system 110 is implemented can include an interface that allows a user to organize and gather content items from various content sources, interactively create a content presentation with the gathered content items, and provide recipients access to the content presentation.

As shown in FIG. 2 and as mentioned above, the send service system 110 can include a template manager 202. In general, the template manager 202 facilitates the selection of a template by a user. In some example embodiments, the template manager 202 may interface with the storage manager 210 that maintains various templates 212, as shown in FIG. 2. Additionally, or alternatively, send service system 110 can communicate, via the network 112, with a template repository that maintains additional templates used to create content presentations. The template manager 202 can also facilitate the creation, modification, removal, and/or customization of templates. Additional details regarding the template manager 202 will now be discussed.

In one or more embodiments, the template manager 202 can provide an interface that allows third-party content providers to provide one or more components or content portions of a template. As such, the third-party content providers can provide content portions that embed within a template. Further, the content portions provided by the third-party content providers can interface with their systems and can be dynamically updated by the third-party content provider. In this manner, the template manager 202 can extend the functionality of a template to include components developed, supported, and provided by third-party content providers.

Further, in some example embodiments, the content portions provided by third-party content providers may themselves be extendable. For example, while a content portion provided by a third-party content provider may be a storage component, the third-party content provider may provide a component that enables document analytics, tracking, and/or security. Similarly, the content portion provided by third-party content providers may be a container that contains one or more components provided by a third-party content provider.

In one or more embodiments, the template manager 202 may enable a user to select one or more templates to use in sharing content items with one or more recipients. To illustrate, the template manager 202 may provide a list of available templates to a user. The template manager 202 may then enable the user to navigate through the list of available templates and select a template from the list of available templates to use in creating a content presentation.

In some example embodiments, the template manager 202 may obtain a list of available templates from the storage manager 210. Alternatively, the template manager 202 can obtain the list of templates from a template repository located outside of the send service system 110 (e.g., on a server remote from the send service system 110. In one or more embodiments, the template manager can obtain a list from the storage manager 210 and a template repository, and then compile an aggregated list that includes templates located within the send service system as well as templates located within a remote template repository.

Notwithstanding the location of the templates (e.g., within or remote with respect to the send service system), the template manager 202 can access templates authored and created within or for the send service system. For example, templates can be accessed in connection with an online collaborative marketplace that includes templates authored by users associated with the send service system 110 (e.g., administrators, programmers) or other users (e.g., an individual user, a business). The template marketplace may include free templates or templates for use under a free-license agreement. In addition, the template marketplace may include one or more templates that are available for purchase. In any event, the template manager 202 may assist a user in obtaining, purchasing, and/or contracting to use templates selected by the user.

In providing a list of available templates to a user, the template manager 202 may indicate features associated with each template, such as the various components (e.g., file component, storage component, security component, analytical component, etc.) within the template. Additionally, the template manager 202 can organize templates according to workflow categories. For instance, the template manager 202 can organize available templates by workflow categories, such as image viewing, legal documents, web learning, marketing/sales, calendar, resumes, proposals, flyers, newsletters, catalogs, programs, invitations, advertising, forms, labels, business, surveys/questionnaires, menus, finance/accounting, invoices, student, events, signature required documents, samples, seasonal, miscellaneous, etc. Additionally or alternatively, the template manager 202 can organize the templates according to other organizational schemes, such as content type that the template can accommodate, themes and design of each template, navigability of each template (e.g., if the template requires no, little, or heavy user interaction), cost of a template, popularity, etc.

In some example embodiments, the template manager 202 may list, display, or showcase available templates. Additionally, the template manager 202 may provide a preview of templates that match a user interest. For example, a user may focus interest on a template by preliminarily selecting (e.g., highlight, position a cursor over, choosing an option to preview, etc.) a template in the list of available templates, and the template manager 202 may provide a preview of the preliminarily selected template. More specifically, the template manager 202 may show a preview of the preliminarily selected template by displaying the general layout and/or arrangement of content that the preliminarily selected template would provide if selected. In some instances, the preview may illustrate sample content populated in the preliminarily selected template. Alternatively, in the event that the user has previously selected content to share with recipients, as described below, the preview may display the preliminarily selected template populated with the selected content. In some example cases, the preview may display a scaled down version of the preliminarily selected template, or alternatively, may display a full sized version of the preliminarily selected template.

In one or more embodiments, the template manager 202 can allow a user to select multiple templates. For example, a user may want to combine two templates together to make a single template. The template manager 202 may combine multiple selected templates together in an order specified by the user. Alternatively, the template manager 202 may automatically merge combinable portions of each template into a single template. Further, the template manager 202 may enable the user to save the combined template as a new template. For example, the template manager 202 may allow the user to save the combined template within the send service system 110 and/or posting the combined template to a template repository.

In the case that a user does not identify a template that is suited the user's needs, the template manager 202 can assist the user in creating a suitable template. In particular, the template manager 202 can provide tools, such as web tools, that allow the user to build and design a customized template. For example, the template manager 202 may provide web tools that enable the user to add, remove, rearrange, resize, connect, split, and/or modify components of a template. As described below, the template manager 202 can also assist the user in adding one or more conditions, controls, and/or restrictions to the template. Further, as described above, the template manager 202 can help the user save the customized template to the user client device and/or post the customized template to the template repository. For instance, if the user creates a template, the template manager 202 can assist the user in posting the template in the template repository for others to use and/or purchase.

Similarly, in some embodiments, the template manager 202 may provide an interface which includes tools to allow a user for modify and customize a template to create a new template better suited to the user's needs. To illustrate, a user may select a template that contains multiple content components or portions. The template manager 202 may provide an interface that enables the user to rearrange the order, layout, and/or arrangement of each component. Further the template manager 202 may allow the user to add additional component, remove one or more components, spilt a single component into multiple components, combine multiple components together, resize one or more components, change the navigational order between multiple components, and/or impose conditions on one or more components.

In one or more embodiments, the template manager 202 may assist a user in identifying a template to select. For example, the template manager 202 may provide a search function to a user that allows the user to search for available templates. Additionally, the template manager 202 can analyze selected content items, user history, and/or other relevant data to provide one or more template suggestions to the user.

For example, in one or more embodiments, a user may identify one or more content items (e.g., videos, images, documents) prior to selecting a template. When the user has identified one or more content items prior to selecting a template, the template manager 202 may filter a list of available templates based on one or more characteristics of the identified content items. To illustrate, for example, the template manager 202 may determine that the user has identified a group of images to share. As such, the template manager 202 may filter out available templates that cannot accommodate images. Further, the template manager 202 may recommend one or more available templates to the user that has a workflow tailored to viewing images. As another illustration, the template manager 202 may identify documents, graphics, images, and charts as part of the content selected by the user. As such, the template manager 202 may recommend templates, or workflow categories, that are can accommodate each of the identified content types.

In one or more additional embodiments, the template manager 202 can assist a user in personalizing the theme, color, and scheme of a template. For example, the template manager 202 may assist the user to add branding information and graphics (e.g., a company name, logo, and contact information) to a template. The template manager 202 can enable the user to add a color scheme, font style, and/or theme to the template, as well as apply other user preferences (e.g., personalized customizations) to the selected template. Further, the template manager 202 can maintain one or more user preferences set by the user and automatically apply the user preferences to future templates.

Further, the template manager 202 may assist a user in adding controls to a template. For example, the template manager 202 can provide control options that allow the user to specify which conditions, if any, should be applied to the template as a whole, or to individual portions of the template. For example, the template manager 202 may allow a user to enter a condition that a recipient read and/or view a portion of a content presentation before the recipient can advance to another portion of the content presentation. Upon receiving user input, the template manager 202 can associate the controls with the template.

As mentioned above, the send service system 110 can include a content manager 204. In general, the content manager 204 may enable a user to select one or more content items to share with one or more recipients. For instance, the content manager 204 may enable the sender 102, for example, to select content items located on the sender client device 104. Additionally, the content manager 204 can communicate with the storage manager 210 to access content items maintained by the send service system 110. Further, the content manager 204 may interface with one or more third-party content providers to obtain content items for the user to incorporate within a content presentation. Additional detail regarding the content manager 204 will now be provided.

In one or more embodiments, the content manager 204 can provide the user the ability to choose content items to share with the recipients when the content items are located on one or more third-party content providers. To illustrate, if the user has access to a third-party content provider, the user may authorize the content manager 204 to access the third-party content provider. For example, the user may provide one or more authentication credentials (e.g., username, password, token, key) or may authorize the content manager 204 via a third-party authentication service (e.g., via a social media network, email service). Upon receiving authorization, the content manager 204 may interface with the third-party content provider, access content items maintained by the third-party content provider, and provide a listing of available content items from which a user can choose.

Upon receiving an indication of a user selecting one or more content items located on a third-party content provider, the content manager 204 can obtain the selected content items. For example, the content manager 204 can download a copy of a selected content item to the send service system 110 and store the selected content item within the storage manager 210. Alternatively, the content manager 204 may store a link to the content item chosen by the user to retrieve the selected content item at a later time.

The content manager 204 can interface with a plurality of third-party content providers. In one example embodiment, the content manager 204 can provide an interface that displays various third-party content provider options. A user can select one or more third-party content providers along with corresponding authentication information, and in response the content manager 204 can display a list of content items located at each third-party content provider. In one or more embodiments, the content manager 204 can provide an aggregated listing of content items that are maintained at a plurality of third-party content providers. Alternatively, the content manager 204 can provide a listing of content items for each third-party content provider separately. As such, the send service system 110 enables the user to easily and efficiently access and share content items from multiple third-party content providers using the send service system 110. In some example embodiments, the content manager 204 may provide an interface to assist a user in choosing content items to share with one or more recipients. For example, the content manager 204 may provide the user with a web interface that allows the user to preview and select multiple content items to share.

Notwithstanding a particular source of a content item, in one or more embodiments, the content manager 204 can monitor a content item used within a content presentation to determine if a user has updated, modified, or removed the content item. For example, the content manager 204 can monitor the last modified date of the content item and/or monitor the contents within the content item to determine if and when any change occurs. To illustrate, the user, or another user who has access to the content item on the third-party content provider, may modify content within the chosen content item. Subsequently, the content manager 204 may detect that the user, or another user, has changed the content item. As will be explained in more detail below, upon detecting a modified content item, the content manager 202 can update a content presentation that incorporates the previous version of the content item.

In addition to the content manager 204, and as mentioned above, the send service system 110 can include a presentation creator 206. In general, the presentation creator 206 populates a template selected by a user based on content items chosen by the user. Further, the presentation creator 206 can create a content presentation from the populated template such that the user can share the content items within the content presentation with one or more recipients.

In one or more embodiments, the presentation creator 206 may populate the one or more templates selected by the user with one or more content items. More specifically, the presentation creator 206 may identify user-specified content items, or portions of content from user-specified content items. The presentation creator 206 may also determine a content type for each portion of content identified. The presentation creator 206 may them populate portions of the selected template based on corresponding the content items and/or the content within the content items.

As a non-limiting example, the presentation creator 206 may determine whether an identified portion of content includes text, an image, a graphic, or a combination thereof. Using the identified portions of content, the presentation creator 206 can populate corresponding portions in the template selected by the user. As another example, the presentation creator 206 can identify text within a selected content item, and in response, may the presentation creator 206 may incorporate the text within a portion of the selected template that corresponds to text. Similarly, the presentation creator 206 can populate graphic portions of the selected template with one or more graphics identified in the chosen content items.

In some example embodiments, the presentation creator 206 can provide an interactive interface that allows a user to customize how content items are incorporated within a template. For example, the presentation creator 206 may provide an interface that highlights a portion of the selected template, as well as provide the user with an option to select a content item that appropriately corresponds to the highlighted portion of the template. The presentation creator 206 may then populate the highlighted portion as indicated by the user. The process of highlighted different portions of the template and populating the highlighted portion with content items may continue until each portion of a template is populated. In an alternative embodiment, the presentation creator 206 may automatically populate the selected template with one or more portions of content and/or content items.

Regardless of how the presentation creator 206 populates the selected template, the presentation creator 206 may enable the user to modify the content within the populated template. For example, the presentation creator 206 may provide an interface, such as a web interface, that allows the user to modify portions of identified content populated the selected template. To illustrate, the presentation creator 206 may automatically populate the selected template with images (e.g., images being the chosen content items selected by the user). The presentation creator 206 may then provide tools that allow the user to rearrange the images within the populated template.

In one or more embodiments, the presentation creator 206 may enable a user to manually populate portions of the selected template. For example, the presentation creator 206 may enable the user to input text or a graphic into a selected portion of the template. In other words, the user may input content into a portion of the populated template using content not obtained from a chosen content item, but rather input directly from the user. Additionally, the user may add to, supplement, edit, or replace any content, such as text, presently included in the portion of the selected template.

As mentioned above, the presentation creator 206 can create a content presentation that allows the user to share content items in a controlled manner designated by the user. More specifically, the presentation creator 206 can finalize or convert a populated template into a content presentation. For example, the presentation creator 206 can create a file, such as a portable document file (PDF), based on the populated template. As described above, the presentation creator 206 can create a content presentation that allows the user to share multiple content items together, and in an organized and controlled manner specified by the user.

The presentation creator 206 can present a copy or demonstration preview of the content presentation to the user. For example, the presentation creator 206 can allow the user to navigate the content presentation as if the user was viewing the content presentation as a recipient. In particular, the presentation creator 206 may require, or otherwise allow, the user to follow the conditions and controls specified by the user. The presentation creator 206, however, may also provide navigational options to allow the user the skip through conditions and/or exit the demonstration preview at any time. For example, if the user identifies an error in a specified condition, the user can exit out of the demonstration preview, make the correction, and re-enter the demonstration preview at the location the correction was made.

In one or more embodiments, the presentation creator 206 can store the presentation on the send service system 110. Additionally, the presentation creator 206 can generate a link to access the created presentation stored on the send service system 110. In some embodiments, the user may select multiple recipients with which to share the presentation. In these embodiments, the presentation creator 206 may generate a unique access link for each recipient with whom the user wants to share the presentation.

In some example embodiments, the presentation creator 206 may receive a notification when the user or another user has updated, modified, removed, or changed a content item incorporated within a content presentation. As described above, the content manager 204 may detect a change in a content item, such as when a user updates a content item stored on a third-party content provider. Upon detecting the change, the presentation creator 206 may determine if the content affects content within the populated template. If the presentation creator 206 determines that content within the populated template has changed, the presentation creator 206 may update the corresponding content within the populated template. Further, the presentation creator 206 may create an updated presentation and store the updated presentation on the send service system 110 (e.g., within storage manager 210). Then, when a recipient later requests to access the content presentation using the communication provided to the recipient before the change in content occurred, the presentation creator 206 may provide the recipient with access to a content presentation that includes the updated content.

As illustrated in FIG. 2 and as mentioned above, the send service system 110 includes an access manager 208. In general, the access manager 208 can assist a user in selecting one or more recipients with whom to share a content presentation. Additionally, the access manager 208 can control access to a content presentation for the one or more recipients identified by the user. Further, the access manager 208 can track access to a content presentation, monitor navigation through a content presentation, and/or report analytics to the sender of a content presentation. Additional detail regarding the access manager 208 will now be described.

In one or more embodiments, the access manager 208 can assist a user in identifying one or more recipients with whom to share the presentation. For example, the access manager 208 may prompt the user to input one or more recipients with whom to share the presentation. The user may manually enter in contact information associated with each recipient, such as entering an email address, instant message handle, or other contact information.

In some example embodiments, the access manager 208 may provide a list of contacts to the user and the user can select one or more contacts from the list of contacts. The access manager 208 may obtain the list of contacts from a user client device, such as a contacts list located on the user client device. Additionally, the access manager 208 may obtain the list from the send service system 110. For example, the send service system 110 may maintain a list of contacts, including contacts with which the user has previously shared content and/or presentations. Additionally or alternatively, the access manager 208 may obtain the list from a third-party content provider associated with the user. For instance, the access manager 208 may access (e.g., import, link to, lookup, etc.) the user's contacts from a third-party content provider.

In an additional or alternative embodiment, the access manager 208 may provide the user with a list of the user's social media contacts from a social media system. For instance, the access manager 208 may interface with a social media system and allow the user to select one or more recipients with whom to share a content presentation from the user's social media contacts. In some example embodiments, the access manager 208 may draw potential recipients from multiple sources (e.g., a contact list on the user's client device, a contact list maintained by the send service system 110, and a contact list from a social media system).

Once the user selects recipients with whom to share the presentation, the access manager 208 may create and send an electronic communication to each selected recipient. The electronic communication may include an access element that allows the recipient of the electronic message to access a content presentation. In one or more embodiments, the access element includes a user-selectable element that, when selected by a recipient, causes a computing device to execute a set of instructions associated with the access element, which in turn, causes the computing device to access a content presentation via the send service system. For example, an access element can include a hyperlink (“link”), a selectable button, or any other selectable graphical element.

To illustrate, an the access manager 208 can generate an electronic communication that includes a link to a content presentation stored on the send service system 110, e.g., a content presentation from amount the content presentations 216 stored within storage manager 210, as illustrated in FIG. 2. For example, the link may be a universal resource link (URL) that, when followed (e.g., selected, entered into a browser, etc.), loads a content presentation hosted by the send service system 110. Alternatively, the access manager 208 may include multiple links in the electronic communication. For instance, the access manager 208 may include links to different versions (e.g., a PDF version, a HTML web version, a document versions, a downloadable version, etc.) or formats (e.g., a print quality format, a screen viewing format, a mobile device format, etc.) of a content presentation. In some instances, the communication may include a HTML message that loads and displays the presentation in the communication itself, and allows the recipient to directly interact with the content presentation within the communication. Alternatively, in some embodiments, the communication may include a copy of the content presentation.

In additional embodiments, the communication may include additional content along with one or more links to the content presentation. For example, the communication may include a message indicating that the user is sharing content items with the recipient via the send service system 110. The communication may also include a preview of the content presentation, such as one or more images of the content presentation, a snippet of content from the content presentation, or a reduced-sized version of the content presentation.

In one or more embodiments, the access manager 208 may send an electronic communication to each selected recipient. The access manager 208 may send the same link to each recipient with whom the user is sharing the presentation. When multiple recipients receive the same link, the access manager 208 may require the recipient to provide identification (e.g., login, provide a name, etc.) before providing access to the content presentation. In this manner, the access manager 208 can track which recipients access the content presentation.

Alternatively, the access manager 208 may generate and provide a unique link for each selected recipient, wherein the unique link is specifically associated with a particular recipient. For example, the access manager 208 can associate a unique link with a particular recipient. When the particular recipient interacts with the unique link, the access manager 208 can identify the unique link, and therefore, identify the particular recipient that is accessing the content presentation. As such, the access manager 208 may track access on a recipient-by-recipient basis without requiring each recipient to provide identification information.

The access manager 208 may use a variety of channels to send an electronic communication to the selected recipients. For example, the access manager 208 may send an electronic communication in an email, instant message, and/or a direct message to a recipient. Additionally or alternatively, the access manager 208 may send the communication via the third-party content provider. The access manager 208 may send the communication to a recipient via a social media system (e.g., TWITTER, FACEBOOK, GOOGLE+, TUMBLR, REDDIT, etc.) to which the user belongs. For instance, the access manager 208 may tweet the communication to a recipient, or post the communication on a recipient's communication feed.

When a selected recipient receives an electronic communication, the recipient may request to access the content presentation. For example, if a selected recipient receives a link, the recipient may select the link to access the content presentation. In response, the access manager 208 can provide the recipient access to the content presentation maintained by the send service system 110. For instance, the access manager 208 may provide a web interface associated with the send service system 110 that provides a display of the presentation.

In some embodiments, the access manager 208 can verify that the selected recipient is authorized to access the content presentation. For instance, the access manager 208 may verify that the user has selected the recipient to access the content presentation and that the user has not revoked access for the recipient to access the content presentation. Further, the access manager 208 may verify that conditions specified by the user are satisfied before providing the recipient access to the content presentation. For example, the access manager 208 may verify that the recipient understands, acknowledges and agrees to the conditions imposed by the user, such as the condition that the recipient may only view the presentation a limited number of times. As another example, the access manager 208 may verify that a recipient is accessing the content presentation within a specified time period (e.g., the link is not expired), or a time period specified by the user (e.g., a day, week, month).

In one or more embodiments, the access manager 208 may control a recipient's navigation of the content presentation based conditions specified by the user and/or the workflow-type selected by the user. For instance, the access manager 208 may allow a recipient to only view the presentation in a particular order, at a specified pace (e.g., a timed quiz), or a limited number of times. In another instance, the access manager 208 may require that a recipient view and/or read an entire portion of the content presentation before allowing the recipient to access another portion of the content presentation.

To illustrate, for example, the access manager 208 may provide a recipient access to a content presentation that is based on a template that includes a document reviewing portion and an interaction portion. The document-reviewing portion may include legal documents. The interaction portion may prompt for a signature to be applied to the legal documents. In this example, the access manager 208 may require that a recipient read and/or view the reviewing portion in its entirely before allowing the recipient to access the interaction portion and sign the provide a signature (e.g., electronic signature).

Similarly, in some example embodiments, the access manager 208 may require a recipient to provide input in one portion of a content presentation before allowing the recipient access to an additional portion of the content presentation. For example, in the case of a web learning presentation, or a survey, the access manager 208 may require a recipient to answer one or more questions pertaining to currently displayed content before allowing the recipient to advance to additional content. Further, the access manager 208 may block a recipient from returning to previous portions of content within the content presentation.

In one or more embodiments, the access manager 208 can track access of the content presentation by each selected recipient. For instance, the access manager 208 can maintain a record of each recipient who has accessed the content presentation, how a recipient accessed the content presentation (e.g., viewed, interacted with, download, and/or time spend viewing), the device used to access the content presentation, and/or how many times a recipient accessed the content presentation. In addition, the access manager 208 may monitor each recipient's navigation through the content presentation. For example, the access manager 208 may monitor how long a recipient spent on each portion of the content presentation, if a recipient completed viewing and/or interacting with the content presentation, if recipients were having trouble or difficultly navigating through any part of the content presentation, if a recipient has skipped any portion of the presentation, etc.

Based on tracking and monitoring each recipient's access and interaction with a content presentation, the access manager 208 may send a report to the user. The report may include tracked and/or monitored information, for example, a listing of recipients that have viewed the content presentation and a listing of recipients that have not yet viewed the content presentation. To illustrate, for example, in the case the content presentation includes a web learning assignment sent by a teacher to students in the teacher's class, the access manager 208 may send a report to the teacher indicating which students have accessed the web learning assignment, which students have completed the web learning assignment, and/or which students, if any, have not accessed the web learning assignment. Further, in connection with the report, the access manager 208 may enable the teacher to request the access manager 208 to send reminders out to the students who have not completed the web learning assignment. Additionally, the access manager 208 can send a report to the teacher when each or every student has completed the assignment, or when the deadline for completing the web learning assignment has past.

The access manager 208 may also provide analytics regarding recipients accessing and interacting with the content presentation. For instance, the access manager 208 may analyze data gathered from tracking recipient's access to the content presentation and data gathered from monitoring how recipients interacted with the content presentation. To illustrate, continuing the example from the above paragraph, the access manager 208 may also provide the teacher with results of the web learning assignment. Results can include individual and/or average student scores on the web learning assignment, if the students had difficultly with any particular portion of the web learning assignment, and other information, such as the time student took to complete the assignment.

Accordingly, the access manager 208 may report the analytics to the user. Based on the analytics report, the user can modify the content presentation. For example, if recipients are struggling to navigate through a particular portion of the content presentation, the user can modify the portion to improve navigation. For instance, the user can split the portion into multiple portions, move the portion to another location, or change the content in the portion.

Additionally or alternatively, the access manager 208 can communicate analytic information with the presentation creator 206, and the presentation creator 206 can use the information to modify the content presentation. In one or more embodiments, the presentation creator 206 can provide a draft version of the modified presentation to the user prior to implementing the modifications in the available version of the content presentation. The user, after reviewing the modification, can accept the modification, further edit the content presentation, or deny the modification. Alternatively, in one or more embodiments, the presentation creator 206 can use information received from the access manager 208 to automatically modify a content presentation.

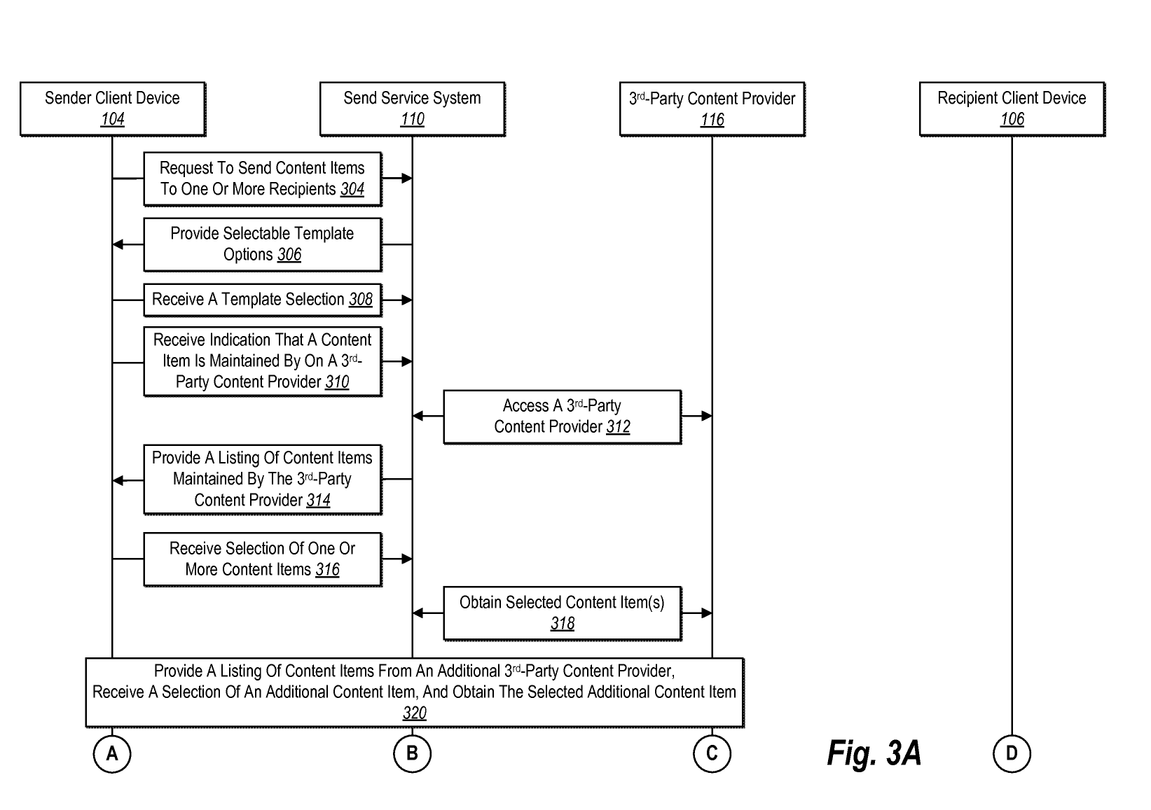

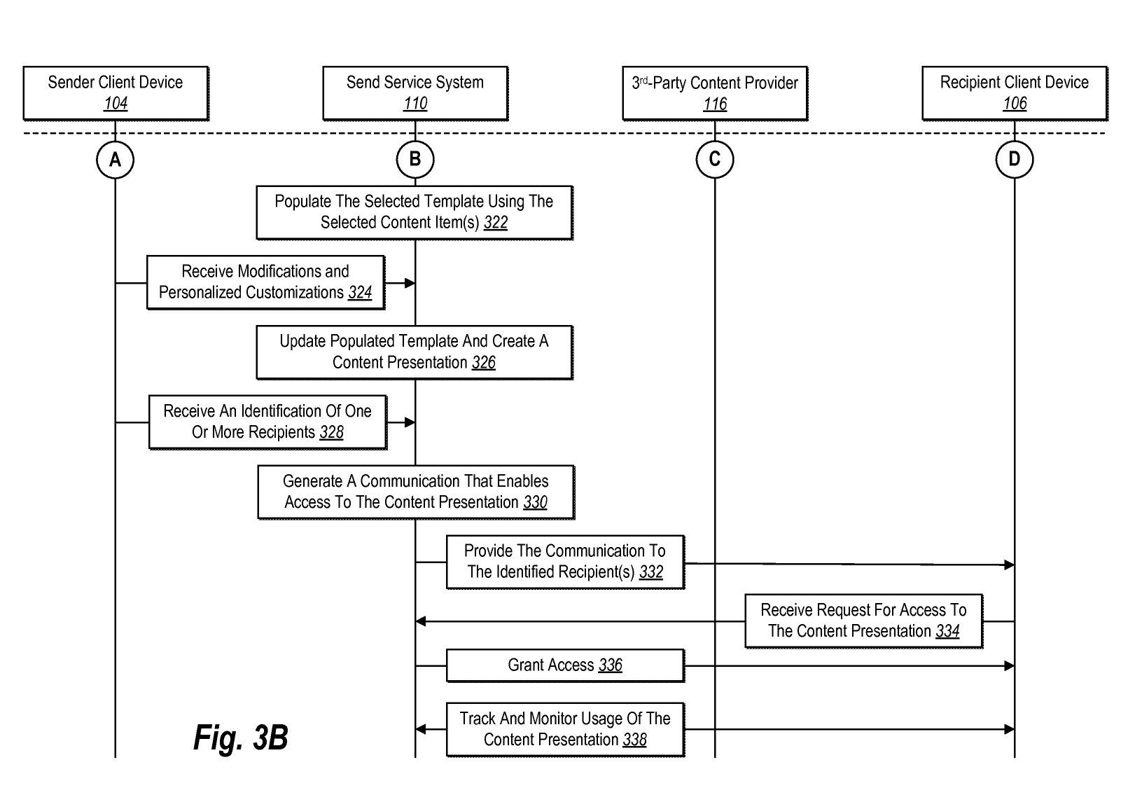

FIGS. 3A-3B illustrate interactions between a sender client device 104, a send service system 110, a third-party content provider 116, and a recipient client device 108 in accordance with one or more embodiments. The sender client device 104, send service system 110, third-party content provider 116, and recipient client device 108 may be example embodiments of corresponding devices, systems, and services described above in connection with FIGS. 1-2.

As disclosed above, a sender using the sender client device 106 may use the send service system 110 to share content items located on the third-party content provider 116 with a recipient using the recipient client device 108. To illustrate, step 304 shows a sender (via the sender client device 104) requesting to send content items to one or more recipients. In particular, the sender client device 104 may send the request to the send service system 110. The request can be sent as a result of the sender accessing the send service system 110 via an interface, and indicating the sender wants to create a new content presentation (e.g., create a new project).

In step 306, the send service system 110 can provide selectable template options to the sender client device 104. More specifically, the send service system 110 can obtain available templates, as described above, and provide the available templates to the sender client device 104 for the sender to select a template. As described above, the sender service system 110 can organize and provide/display available templates in a variety of ways to assist the sender in selecting a template appropriate for the content items the sender desires to share.

As shown in step 308, the send service system 110 may receive the user's template selection. In other words, the sender client device 104 can send a template selection to the send service system 110. In particular, the sender can view the available templates presented on the sender client device 104 and select a template to use in sharing content items with other recipients. Upon selecting an available template, the sender client device 104 can send the selection to the send service system 110.

In step 310, the send service system 110 may receive an indication from the sender client device 104 that a content item that sender wants to share is located on a third-party content provider. More specifically, the sender may provide input to the send service system 110 that the user would like to share a content item maintained by a third-party content provider. In some embodiments, the sender will need to authorize the send service system 110 to access and obtain the content item from the third-party content provider. In other embodiments, the user may have previously authorized the send service system 110 to interface with the third-party content provider.

Next, and as illustrated in FIG. 3A, the send service system 110 may access the third-party content provider, as illustrated in step 312. For example, the send service system 110 may use API calls provided by the third-party content provider to access a content item directory on the third-party content provider. In particular, the send service system 110 may obtain a listing of content items associated with the user from the third-party content provider.

In step 314, as shown in FIG. 3A, the send service system 110 may provide the sender client device 104 with a listing of content items maintained by the third-party content provider to allow the user to choose a content item from the third-party content provider. In step 316, the send service system 110 may receive a selection of a content item for the sender client device 104. Upon the user selecting a content item from the third-party content provider, the sender client device 104 may send the selection to the send service system 110. Based on the selection, the send service system 110 can obtain the selected content item from the third-party content provider, as shown in step 318 and as described above. Accordingly, the user may choose a content item that is stored on the third-party content provider to share with other recipients via the send service system 110.

The user may also want to include content items stored on another third-party content provider when sharing multiple content items via the send service system 110. For example, the user may request that the send service system 110 obtain an additional content item stored on another third-party content provider. As shown in step 320, the send service system 110 may provide a listing to the sender client device 104 of content items available on the additional third-party content provider, receive a selection of the content item the user wants to share, and obtain the selected content item from the additional third-party content provider. In particular, the send service system 110 may perform similar steps as steps 310-318 with respect to the additional third-party content provider. As such, the send service system 110 may facilitate the steps of requesting, accessing, and selecting an addition content item from another third-party content provider. Further, while not illustrated in FIG. 3, the send service system 110 may enable the user to select additional content items from other additional third-party content provider 116, as described above.

In step 322, illustrated in FIG. 3B, the send service system 110 may populate the selected template using the content item(s) selected by the sender. As described above, the send service system 110 may identify content from within the content items selected by the sender and populate the template selected by the sender with the identified content. Further, the send service system 110 may receive user modifications to the content within the populated template as well as personalized customizations to the selected template, as shown in step 324 and as described above. As part of populating, customizing, and personalizing the selected and populated template, the send service system 110 may apply conditions and controls associated with the template as well as those specified by the sender, as described in detail above.

Upon receiving input from the sender regarding the input, layout, arrangement, and conditions of the populated template, the send service system 110 may update the populated template and create a content presentation to share with recipients, as step 326 illustrates. In step 328, the send service system 110 may receive a selection of one or more recipients from the sender client device 104. In particular, the sender client device 104 may indicate one or more recipients with whom to share the multiple content items by way of the content presentation. As described above, the send service system 110 may provide a list of contacts to the sender, which may include the sender's social media contacts and/or the sender's contacts from the third-party content provider.

The send service system 110 may generate a communication that enables access to the content presentation, as shown in step 330. The communication may include a link to the content presentation stored on the send service system 110. Further, as described above, the communication may include a message from the send service system 110 or the user indicating that the user is sharing multiple content items with the recipient via a presentation stored on the send service system 110. The communication may also include one or more conditions, specified by the user, with which the recipient needs to comply before gaining access to the content presentation.

In step 332, and as illustrated in FIG. 3B, the send service system 110 may provide the communication that includes an access element to the identified recipients. In step 334, the send service system 110 may receive a request to access the content presentation from a recipient of the selected recipients (e.g., a recipient client device 108 associated with a recipient). In response, the send service system 110 may grant access to the content presentation, as illustrated in step 336.

In step 338, the send service system 110 may track and monitor the recipient's usage (e.g., access, interactions) with the content presentation. For example, the send service system 110 may track which selected recipients have accessed the content presentation and monitor interactions between the selected recipients and the content presentation as described above. Also, as described above, in some example embodiments, the send service system 110 may provide reports to the user indicating the status of each selected recipient with respect to the content presentation.

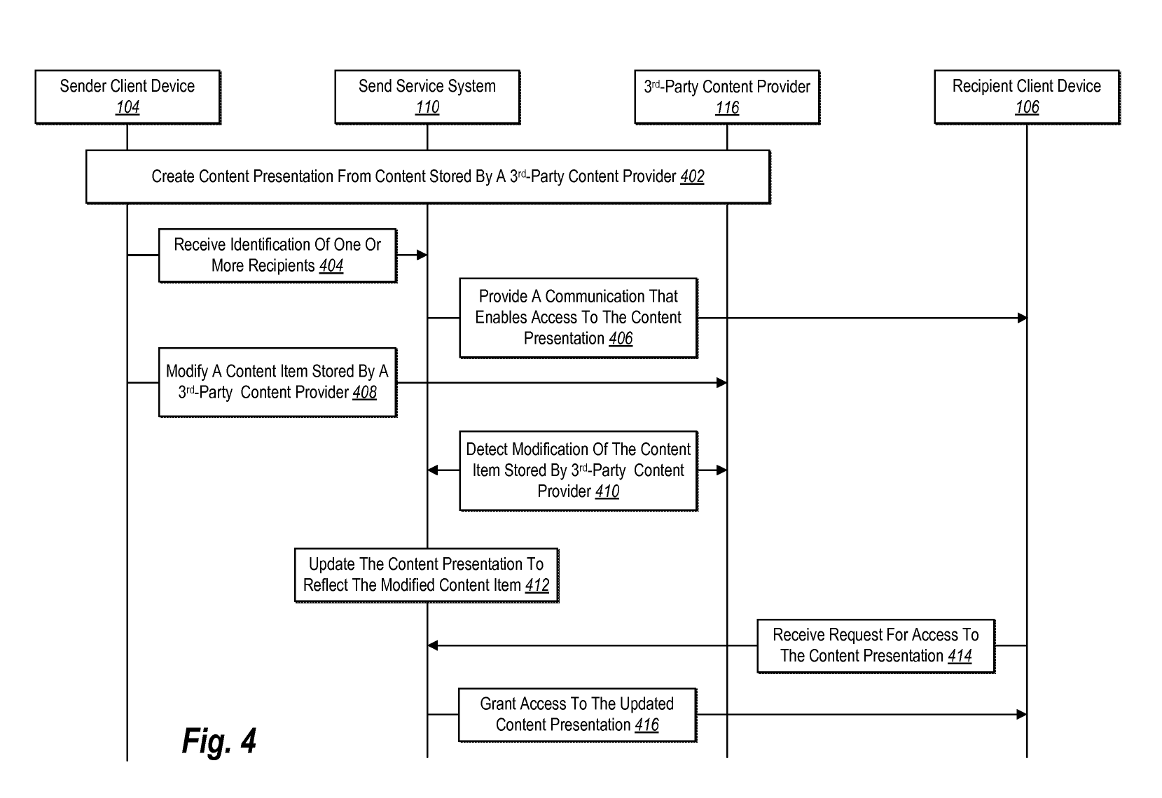

FIG. 4 also illustrates interactions between a sender client device 104, a send service system 110, third-party content provider 116, and a recipient client device 108 in accordance with one or more embodiments. The sender client device 104, send service system 110, third-party content provider 116, and recipient client device 108 may be example embodiments of corresponding devices, systems, and services described above in connection with FIGS. 1-2.

More specifically, FIG. 4 illustrates an embodiment of the send service system 110 that can dynamically update a content presentation upon detecting a change in content within a content item stored on a third-party content provider. For example, step 402 illustrates the send service system 110 creating a content presentation from content stored on a third-party content provider. For the sake of brevity, step 402 may be similar to step 326 of FIG. 3, which relates to the send service system 110 creating a presentation to share with recipients. As such, steps similar steps 302-324, which are described in connection with FIG. 3, may similarly precede step 402.

In step 404, the send service system 110 may receive a selection of one or more recipients from the sender client device 104. For example, the sender client device 104 may indicate one or more recipients with whom to share the multiple content items. In response to receiving the selection of the recipients with whom to share the presentation, the send service system 110 may provide a communication that enables access to the content presentation, as shown in step 406 and as described above.

In step 408, the user, via the sender client device 104, may change content in a chosen content item stored on the third-party content provider. In other words, the user may modify content within one of the content items that the send service system 110 obtained from the third-party content provider and used to populate the selected template. Because the send service system 110 created the content presentation based on the populated template, content in the content presentation may be incorrect and/or outdated.

In step 410, the send service system 110 may detect that a change occurred to one of the content items used within the content presentation. For example, as described above, the send service system 110 may identify that the modification date for the chosen content item stored on the third-party content provider has changed or is more recent than the modification date of the content presentation. After detecting that the user has updated content within the chosen content item, the send service system 110 can identify which portion of content the user has modified. The send service system 110 may then apply the update to corresponding content in the content presentation to reflect the change in the updated content item, as shown in step 412. In other words, the send service system 110 can identify a change in content in a chosen content item stored on a third-party content provider and dynamically apply the change to the content presentation stored on the send service system 110.

In step 414, the send service system 110 may receive a request to access the content presentation from a recipient of the selected recipients (e.g., a recipient client device 108 associated with a selected recipient). The request may be in response to the communication the send service system 110 sent before the user updated the chosen content item and before the send service system 110 updated the content presentation. Further, the send service system 110, however, may not send a new communication to the selected recipient after updating the content presentation. However, because the content presentation is hosted by the send service system 110, the send service system 110 may replace the outdated content presentation with the updated presentation and still enable access to the content presentation from the original link provided in the communication to the selected recipients.

In step 416, the send service system 110 may grant access to the content presentation. As such, the recipient may access the updated content presentation rather than the previous version of the content presentation. In some example embodiments, the send service system 110 may provide the recipient the option to also view the previous version of the content presentation, if the user permits the option.

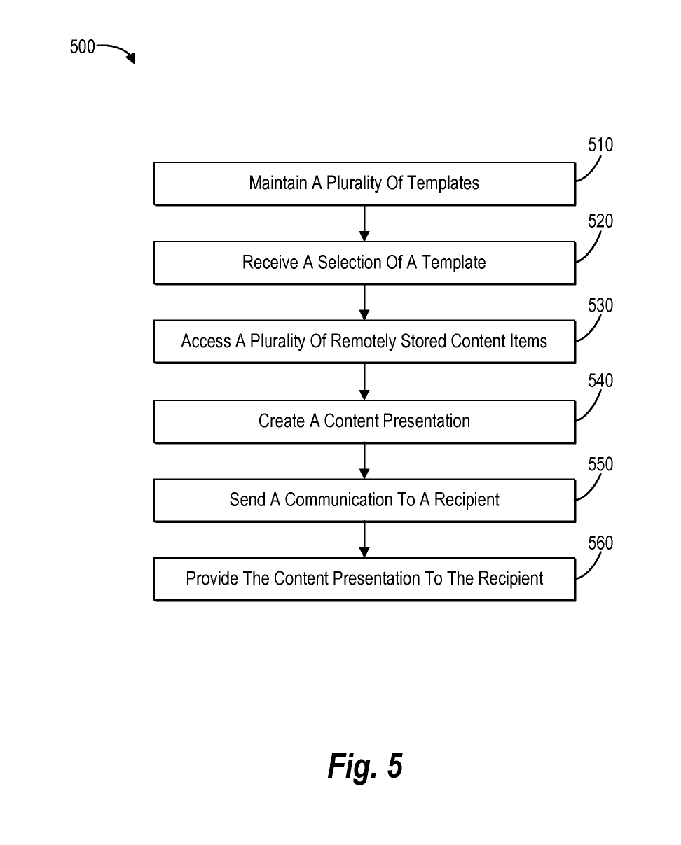

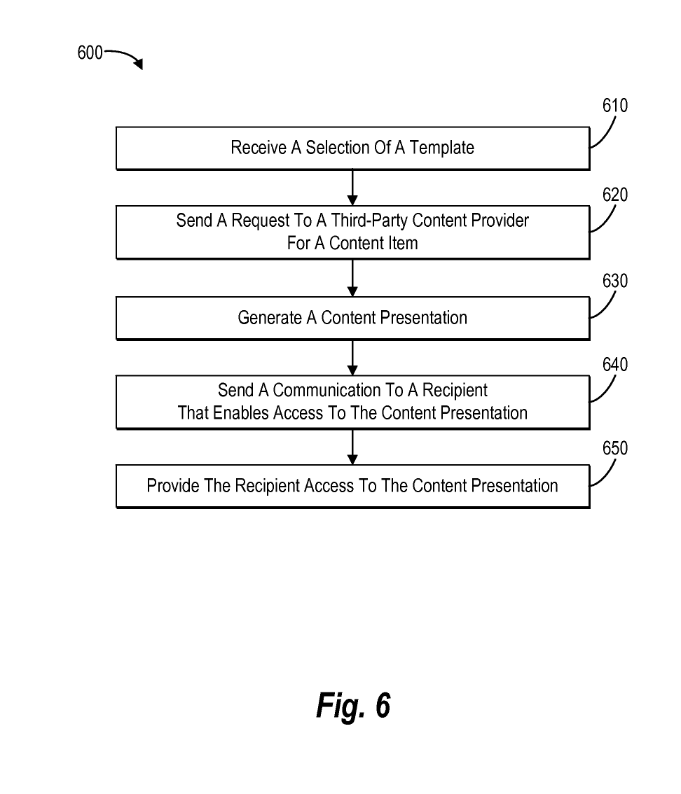

FIGS. 1-4, the corresponding text, and the examples, provide a number of different systems and devices that enables a user (e.g., user) to customize the sending of multiple files to one or more recipients. In addition to the foregoing, embodiments can also be described in terms of flowcharts comprising acts and steps in a method for accomplishing a particular result. For example, FIGS. 5 and 6 illustrate flowcharts of exemplary methods in accordance with one or more embodiments of the present invention. The methods described in relation to FIGS. 5 and 6 may be performed with less or more steps/acts or the steps/acts may be performed in differing orders. Additionally, the steps/acts described herein may be repeated or performed in parallel with one another or in parallel with different instances of the same or similar steps/acts.

FIG. 5 illustrates a flowchart of one example method 500 of sending multiple content items using a send service system in accordance with one or more embodiments described herein. In one or more embodiments, the method 500 is performed in a digital medium environment that includes a send service system 110 accessible over a network. The send service system 110 may provide a file sending service and may host files to be shared between users of the sending service system. Further, the method 500 may include creating and providing access to a presentation of content generated using a user-selected template and user-defined content.

To illustrate, the method 500 includes an act 510 of maintaining a plurality of templates. In particular, the act 510 may involve maintaining, by at least one host server of the send service system 110, a plurality of templates used to create content presentations. For example, act 510 may involve identifying and accessing one or more templates from a template repository 114. In some example embodiments, act 510 may involve maintaining the plurality of templates at an online collaborative marketplace. Further, act 510 may involve restricting the selection of the plurality of templates for use by a sender 102 based on one or more factors, such as the content type of files selected by the sender 102.

The method 500 includes an act 520 of receiving a selection of a template. In particular, the act 520 may involve receiving, from a sender 102, a selection of a template from the plurality of templates. Act 520 may further involve presenting a list of available templates to the sender 102, providing search functionality that enables the sender 102 to search through available templates, and/or providing a user interface to the sender 102 to assist the sender 102 in selecting an available template. Additionally, act 520 may involve displaying a preview of a preliminarily selected template to the sender 102 where the preview displays the layout and arrangement associated with the preliminarily selected template.

Additionally, the method 500 includes an act 530 of accessing a plurality of remotely stored content items. In particular, act 530 may involve receiving, from the sender 102, a selection of plurality of content items. For example, act 530 may involve accessing a plurality of content items remotely stored with respect to the send service system 110. In some example embodiments, act 530 may involve providing a listing of multiple content items to the sender 102 and enabling the sender 102 to select content items from the listing of multiple content items and/or receiving the selection of content items from content items stored on one or more third-party content provider, as described herein.

Further, the method 500 includes an act 540 of creating a content presentation. In particular, act 540 may involve creating, based on the user interacting with an interactive interface within the send service system, a content presentation comprising the selected template populated with one or more of the plurality of content items. For example, act 540 can involve identifying portions of content within the chosen content items, populating the selected template using the identified portions of content, and converting the populated template into one or more versions formats, such as versions and formats suited for a web interface and/or mobile device. Further, act 540 may involve providing a preview of the content presentation to the sender 102, allowing the sender 102 to modify the content presentation, and updating the content presentation based on the user's modifications.

Additionally, the method 500 includes an act 550 of sending a communication to a recipient 106. In particular, act 550 may involve sending, by the send service system 110, a communication to one or more recipients that enables the one or more recipients to access to the content presentation via the send service system 110. For example, act 550 may involve providing a list of contacts to the sender 102 and allowing the sender 102 select one or more recipients from the list of contacts. In some example embodiments, act 550 may involve obtaining the list of contacts from a social media system or third-party content provider associated with the sender 102 and sending the communication via the social media system or third-party content provider from which the sender 102 selected the contact.

The method 500 also includes an act 560 of providing the content presentation to the recipient 106. In particular, act 560 may involve providing, to a recipient 106 of the one or more recipients, access to the content presentation upon the recipient interacting with the communication to request access to the content presentation. For instance, act 560 may involve providing a preview of the shared template within an online interface and/or providing a download of the content presentation to the recipient 106. In some example embodiments, act 560 may also involve determining whether the recipient 106 is currently authorized by the sender 102 to authorize the content presentation.

The method 500 may further include a step of enabling the user to select a first content item of the plurality of content items from a first remote location and select a second content item of the plurality of content items from a second remote location. The first remote location and/or second remote location may be third-party content provider 116. In some example embodiments, the first remote location and the second remote location may be associated with different third-party content provider 116. Further, enabling the user to select a first content item of the plurality of content items from a first remote location may include receiving, from the sender 102, authorization to access a first third-party online content hosting service 116a on behalf of the sender 102, communicating with the first third-party online content hosting service 116a, accessing a list of content items associated with the sender 102 from the first third-party online content hosting service 116a where the list of content items includes the first content item, and enabling the user to choose the first content item from the first third-party online content hosing service 116a.

The method 500 may also include a step of identifying the plurality of templates used to create content presentations based on the plurality of content items. Identifying the plurality of templates used to create content presentations based on the plurality of content items may involve identifying one or more content types corresponding to the plurality of content items and determining the plurality of templates used to create content presentations based on the one or more identified content types. In addition, the method 500 may include a step of enabling the sender 102 to modify the content presentation. Based on the modifications provided by the sender 102, the method 500 may also include updating the content presentation.

In one or more embodiments, the method 500 may include the steps of detecting a change in content within a first content item of the plurality of content items, automatically updating the content presentation based on the detected change in content within the first content item, and providing the updated content presentation to the recipient 106 upon the recipient 106 using the communication to access the shared template. Further, the steps of detecting and providing may involve the recipient requesting access to the content presentation based on the communication sent to the recipient before the content presentation was updated.

FIG. 6 illustrates a flowchart of another example method 600 of sending multiple files to one or more recipients using a send service in accordance with one or more embodiments. In one or more embodiments, the method 600 is performed in a digital medium environment that includes a send service system 110 accessible over a network. The send service system 110 may host content items to be shared between users of the sending service system 110 and interact with a plurality of online content hosing services. Further, the method 600 may include providing a sending service to share content between users of the send service system 110.

To illustrate, the method 600 includes an act 610 of receiving a selection of a template. In particular, the act 610 may involve receiving, from a user 102, a selection of a template from the plurality of template options corresponding with a plurality of content presentation types. Act 610 may also involve displaying a preview of a preliminarily selected template to the sender 102 where the preview displays the layout and arrangement associated with the preliminarily selected template.

The method 600 includes an act 620 of sending a request to a third-party content provider for a content item. In particular, the act 620 may involve sending, to a third-party content provider 116a, a request for one or more content items to be used in association with the selected template. For example, act 620 may involve receiving, from the sender 102, authorization to access the third-party online content provider 116a on behalf of the user 102, communicating with the third-party online content provider 116, accessing lists of content items associated with the user 102 from the third-party online content provider 116a, and sending a request for one or more content items to the third-party online content provider 116a.

The method 600 also includes an act 630 of generating a content presentation. In particular, act 630 may involve generating, on the send service system 110, a content presentation by populating the selected template with the one or more content items received from the third-party content provider 116a in response to the request. In some example embodiments, act 630 may involve determining portions of content within the chosen first content item and the chosen second content item, determining if the identified portions of content correspond to one or more portions of the selected template, and based on the determination, populating the selected template using the identified portions of content. In addition, act 630 may involve creating a content presentation based on the populated template. For example, act 630 can involve converting the populated template into one or more versions or formats, as described above. Further, act 630 may involve providing a preview of the content presentation to the sender 102, allowing the sender 102 to modify the content presentation, and updating the content presentation based on the user's modifications.

Additionally, the method 600 includes an act 640 of sending a communication to a recipient 106 that enables to access the content presentation. In particular, act 640 may involve providing, to a recipient 106, an electronic communication comprising an access element that enables the recipient to access the content presentation via the send service system 110. For example, act 640 may involve providing a list of contacts to a sender 102 and allowing the sender 102 select one or more recipients from the list of contacts to whom to send the link. In some example embodiments, act 640 may involve obtaining the list of contacts from a social media system or third-party content provider associated with the sender 102 and sending the electronic communication via the social media system or third-party content provider from which the sender 102 selected the contact.

The method 600 also includes an act 650 of providing the recipient 106 access to the content presentation 106. In particular, act 650 may involve providing, to the recipient, access to the content presentation via the send service system 110, where the access to the content presentation is provided in response to detecting that the recipient interacted with the access element in the electronic communication. For instance, act 650 may involve providing access to an online web interface of the content presentation, as described herein.

Embodiments of the present disclosure may comprise or utilize a special purpose or general-purpose computer including computer hardware, such as, for example, one or more processors and system memory, as discussed in additional detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates a block diagram of an exemplary computing device 700 that may be configured to perform one or more of the processes described above. One will appreciate that one or more computing devices, such as the computing device 700, may implement the send service system 110. In particular, any of the sender client device 104, the recipient client device 108, the send service system 110, and the template repository 114 can comprise a computing device 700. As shown by FIG. 7, the computing device 700 can comprise a processor 702, memory 704, a storage device 706, an I/O interface 708, and a communication interface 710, which may be communicatively coupled by way of a communication infrastructure 712. While an exemplary computing device 700 is shown in FIG. 7, the components illustrated in FIG. 7 are not intended to be limiting. Additional or alternative components may be used in other embodiments. Furthermore, in certain embodiments, the computing device 700 can include fewer components than those shown in FIG. 7. Components of the computing device 700 shown in FIG. 7 will now be described in additional detail.

In particular embodiments, the processor 702 includes hardware for executing instructions, such as those making up a computer program. As an example and not by way of limitation, to execute instructions, the processor 702 may retrieve (or fetch) the instructions from an internal register, an internal cache, the memory 704, or the storage device 706 and decode and execute them. In particular embodiments, the processor 702 may include one or more internal caches for data, instructions, or addresses. As an example and not by way of limitation, the processor 702 may include one or more instruction caches, one or more data caches, and one or more translation lookaside buffers (TLBs). Instructions in the instruction caches may be copies of instructions in the memory 704 or the storage 706.

The memory 704 may be used for storing data, metadata, and programs for execution by the processor(s). The memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 704 may be internal or distributed memory.

The storage device 706 includes storage for storing data or instructions. As an example and not by way of limitation, the storage device 706 can comprise a non-transitory storage medium described above. The storage device 706 may include a hard disk drive (HDD), a floppy disk drive, flash memory, an optical disc, a magneto-optical disc, magnetic tape, or a Universal Serial Bus (USB) drive or a combination of two or more of these. The storage device 706 may include removable or non-removable (or fixed) media, where appropriate. The storage device 706 may be internal or external to the computing device 700. In particular embodiments, the storage device 706 is non-volatile, solid-state memory. In other embodiments, the storage device 706 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 708 allows a user to provide input to, receive output from, and otherwise transfer data to and receive data from the computing device 700. The I/O interface 708 may include a mouse, a keypad or a keyboard, a touch screen, a camera, an optical scanner, network interface, modem, other known I/O devices or a combination of such I/O interfaces. The I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 708 is configured to provide graphical data to a display for presentation to a user. The graphical data may be representative of one or more graphical user interfaces and/or any other graphical content as may serve a particular implementation.

The communication interface 710 can include hardware, software, or both. In any event, the communication interface 710 can provide one or more interfaces for communication (such as, for example, packet-based communication) between the computing device 700 and one or more other computing devices or networks. As an example and not by way of limitation, the communication interface 710 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 710 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 710 may facilitate communications with a wireless PAN (WPAN) (such as, for example, a BLUETOOTH™ WPAN), a WI-FI network, a WI-MAX network, a cellular telephone network (such as, for example, a Global System for Mobile Communications (GSM) network), or other suitable wireless network or a combination thereof.

Additionally, the communication interface 710 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 712 may include hardware, software, or both that couples components of the computing device 700 to each other. As an example and not by way of limitation, the communication infrastructure 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. In a digital medium environment comprising a send service system accessible over a network, a method for creating and providing access to a presentation of content generated using a user-selected template and user-defined content, the method comprising:
maintaining, by at least one server of the send service system, a plurality of templates used to create content presentations;
receiving, from a user, a selection of a template from the plurality of templates;
accessing a plurality of content items remotely stored with respect to the send service system;
creating, based on the user interacting with an interactive interface within the send service system, a content presentation comprising the selected template populated with one or more of the plurality of content items;
sending, by the send service system, a communication to one or more recipients that enables the one or more recipients to access the content presentation via the send service system; and
providing, to a recipient of the one or more recipients, access to the content presentation upon the recipient interacting with the communication to request access to the content presentation.

2. The method of claim 1, further comprising enabling the user to select a first content item of the plurality of content items from a first remote location and select a second content item of the plurality of content items from a second remote location.

3. The method of claim 2, wherein the first remote location is associated with a first third-party content provider and the second remote location is associated with a second third-party content provider, the first third-party content provider being different from the second third-party content provider.

4. The method of claim 3, wherein enabling the user to select the first content item from the first third-party content provider comprises:
receiving, from the user, authorization to access the first third-party content provider on behalf of the user;
accessing a list of content items associated with the user from the first third-party content provider, the list of content items including the first content item; and
enabling the user to choose the first content item from the list of content items provided by the first third-party content provider.

5. The method of claim 1, further comprising identifying the plurality of templates used to create content presentations based on the plurality of content items.

6. The method of claim 5, wherein identifying the plurality of templates used to create content presentations based on the plurality of content items comprises:
identifying one or more content types corresponding to the plurality of content items; and
filtering the plurality of templates used to create content presentations based on the one or more identified content types.

7. The method of claim 1, wherein maintaining the plurality of templates used to create content presentations comprises maintaining the plurality of templates at an online collaborative marketplace.

8. The method of claim 1, further comprising enabling the user to modify the content presentation.

9. The method of claim 8, further comprising updating the content presentation based on the user modifying the content presentation.

10. The method of claim 1, further comprising:
subsequent to sending the communication to one or more recipients that enables access to the content presentation via the send service, detecting a change in a first content item of the plurality of content items;
updating the content presentation based on the detected change in the first content item;
receiving, from the recipient of the one or more recipients, a request to access the content presentation based on the communication sent to the recipient prior to the detected change in content within the first content item; and
providing the updated content presentation to the recipient of the one or more recipients upon the recipient using the communication to access the content presentation.

11. In a digital medium environment comprising a send service system accessible over a network that provides a sending service by maintaining content to be shared between users of the send service system, the method comprising:
receiving, from the user, a selection of a template from a plurality of templates accessible to the sending service system;
receiving, from the user, a selection of a first content item from a first third-party content provider and a selection of a second content item from a second third-party content provider, the second third-party content provider being different from the first third-party content provider;
interfacing with the first third-party content provider to obtain the first file;
interfacing with the second third-party content provider to obtain the second file;
populating the selected template using content from the first file and the second file;
creating a content presentation based on the populated template;
sending, to one or more recipients, a link that enables the one or more recipients to access the content presentation; and
providing access to the content presentation to a recipient of the one or more recipients upon the recipient using the link to access the content presentation.

12. The method of claim 11, further comprising receiving, from the user, modifications to the selected template, the modification specifying navigational restrictions imposed by the user to be enforced in the content presentation.

13. The method of claim 11, further comprising receiving, from the user, personalized customizations to the populated template.

14. The method of claim 11, further comprising
providing a plurality of templates accessible to the sending service system to the user; and
restricting the plurality of templates provided to the user based on content type of the first file and the second file.

15. The method of claim 11, wherein providing access to the content presentation comprises providing a preview of the content presentation within an online interface.

16. The method of claim 15, wherein the online interface is a web interface hosted by the send service system.

17. The method of claim 11, wherein providing access to the content presentation comprises downloading the content presentation from the send service system to a storage location associated with the recipient.

18. The method of claim 11, further comprising:
monitoring access of the content presentation by the one or more recipients; and
reporting the access of the content presentation by the one or more recipients to the user.

19. A send service system for sharing files populated with user-defined content, the send service system being accessible over a network and providing a sending service to share content between users of the send service system, the send service system comprising:
at least one processor; and
at least one non-transitory computer-readable storage medium storing instructions thereon that, when executed by the at least one processor, cause the send service system to:
receive, from a user, a selection of a template from a plurality of template options corresponding with a plurality of content presentation types;
send, to a third-party content provider, a request for one or more content items to be used in association with the selected template;
generate, on the send service system, a content presentation by populating the selected template with the one or more content items received from the third-party content provider in response to the request;
provide, to a recipient, an electronic communication comprising an access element that enables the recipient to access the content presentation via the send service system; and
provide, to the recipient, access to the content presentation via the send service system, wherein the access to the content presentation is provided in response to detecting that the recipient interacted with the access element in the electronic communication.

20. The system of claim 19, wherein providing access to the content presentation via the send service system comprises providing the content presentation within a web interface.
